(19) United States
(12) Patent Application Publication
(10) Pub. No.: US 2021/0195933 A1
(43) Pub. Date: Jul. 1, 2021

(54) PROVIDING NUTRITION FOR AN ACTIVITY

(71) Applicants: Roy Walter HENDERSON, Ndabeni (ZA); Jan Abraham VLOK, Ndabeni (ZA)

(72) Inventors: Roy Walter HENDERSON, Ndabeni (ZA); Jan Abraham VLOK, Ndabeni (ZA)

(21) Appl. No.: 16/754,769

(22) PCT Filed: Oct. 8, 2018
(86) PCT No.: PCT/IB2018/057779

§ 371 Date: Apr. 9, 2020

(30) Foreign Application Priority Data
Oct. 9, 2017 (ZA) 2017/06770
Jun. 8, 2018 (ZA) 2018/03817

(51) Int. Cl. A23L 33/00; A23L 2/385; A23L 2/66; A23L 33/19; A23L 33/125; A23L 33/21; A23L 33/115; A23L 33/185; A23L 33/18; A23L 33/175; A23L 33/15; A23L 33/16; A23L 2/60

(52) U.S. Cl. CPC A23L 33/30; A23L 2/385; A23L 2/66; A23L 33/19; A23L 33/125; A23L 33/21; A23V 2002/00; A23L 33/185; A23L 33/18; A23L 33/175; A23L 33/15; A23L 33/16; A23L 2/60; A23L 33/115

(57) ABSTRACT

The present invention provides a nutrition kit comprising:
a blood sugar stabilizing nutrition of a GI of between about 30 and 40 GI to be consumed for a period of time prior to an activity;
an energy supplement of between about 40 and 50 GI to be consumed for a period of time to an activity;
an energy supplement of between about 50 and 60 GI to be consumed for a period of time closer to the activity; and
an energy supplement of between about 60 and 70 GI to be consumed for an initial period of time during the activity.

This invention relates to a method of providing nutrition for an activity. In particular, the invention relates to a method of providing nutrition for an activity, to a nutrition kit and to a nutritional range.

For the purposes of this specification, the term “activity” is to be interpreted to mean an intended future event during which elevated energy consumption by the human body is to be experienced. Such events include sporting events, or the like, for example.

In accordance with a first aspect of the invention, there is provided a nutrition kit including:

a blood sugar stabilizing nutrition of a GI of between about 30 and 40 GI to be consumed for a period of time prior to an activity;
an energy supplement of between about 40 and 50 GI to be consumed for a period of time prior to an activity;
an energy supplement of between about 50 and 60 GI to be consumed for a period of time closer to the activity; and
an energy supplement of between about 60 and 70 GI to be consumed for an initial period of time during the activity

The energy supplement of between about 60 and 70 GI to be consumed for an initial period of time during the activity may be for consumption for an initial period of no longer than 120 minutes.

The kit may further include an energy supplement of between about 70 and 80 GI to be consumed for a period of time after the initial period of time during the activity.

The nano protein supplement may have a GI of 65 or less.

The nano protein supplement may have greater than 50% protein content. The nano protein supplement may be of from 100 to 4000 Dalton Atomic Weight, preferably 1000 to 3000 Dalton Atomic Weight.

The kit may further include a nano protein and carbohydrate supplement to be consumed after the activity to enhance bodily recovery.

The carbohydrate supplement may be of about 100 GI or more.

The blood sugar stabilizing nutrition may have a GI of about 35 GI.

The kit may include instructions instructing a consumer to consume the blood sugar stabilizing nutrition for about 48 hours prior to the activity.

The energy supplement of between about 40 and 50 GI may have a GI of about 45 GI.

The kit may include instructions instructing a consumer to consume the energy supplement for about 48 hours prior to the activity.

The energy supplement of between about 50 and 60 GI may have a GI of about 55 GI.

The kit may include instructions instructing a consumer to consume the energy supplement of between about 50 and 60 GI for about 2 hours prior to the activity.

The energy supplement of between about 60 and 70 GI may have a GI of about 65 GI.

The kit may include instructions instructing a consumer to consume the energy supplement of between about 60 and 70 GI for a period of time less than about 120 minutes after commencement of the activity.

The energy supplement of between about 70 and 80 GI may have a GI of about 75 GI.

The kit may include instructions instructing a consumer to consume the energy supplement of between about 70 and 80 GI after about 120 minutes after commencement of the activity.

In accordance with a second aspect of the invention, there is provided a nutritional range including:
a container containing a blood sugar stabilizing nutrition of a GI of between about 30 and 40 GI to be consumed for a period of time prior to an activity;
a container containing an energy supplement of between about 40 and 50 GI to be consumed for a period of time prior to an activity;
a container containing an energy supplement of between about 50 and 60 GI to be consumed for a period of time closer to the activity; and
a container containing an energy supplement of between about 60 and 70 GI to be consumed for an initial period of time during the activity.

The container containing an energy supplement of between about 60 and 70 GI to be consumed for an initial period of time during the activity may be for an initial period of no more than 120 minutes.

The nutritional range may further include a container containing an energy supplement of between about 70 and 80 GI to be consumed for a period of time after the initial period of time during the activity.

The nutritional range may further include a container containing a nano protein supplement to be consumed during the activity.

The nano protein supplement may have a GI of 65 or less.

The nano protein supplement may have greater than 70% protein content.

The nano protein supplement may be of from 100 to 4000 Dalton Atomic Weight, preferably 1000 to 3000 Dalton Atomic Weight.

The nutritional range may further include a container containing a nano protein and carbohydrate supplement to be consumed after the activity to enhance bodily recovery.

The carbohydrate supplement may be of about 100 GI or more.

The blood sugar stabilizing nutrition may have a GI of about 35 GI.

The nutritional range may include instructions instructing a consumer to consume the blood sugar stabilizing nutrition for about 48 hours prior to the activity.

The energy supplement of between about 40 and 50 GI may have a GI of about 45 GI.

The nutritional range may include instructions instructing a consumer to consume the energy supplement for about 48 hours prior to the activity.

The energy supplement of between about 50 and 60 GI may have a GI of about 55 GI.

The nutritional range may include instructions instructing a consumer to consume the energy supplement of between about 50 and 60 GI for about 2 hours prior to the activity.

The energy supplement of between about 60 and 70 GI may have a GI of about 65 GI.

The nutritional range may include instructions instructing a consumer to consume the energy supplement of between about 60 and 70 GI for a period of less than about 120 minutes during the activity.

The energy supplement of between about 70 and 80 GI may have a GI of about 75 GI.

The nutritional range may include instructions instructing a consumer to consume the energy supplement of between about 70 and 80 GI after about 120 minutes after commencement of the activity.

In accordance with a third aspect of the invention, there is provided a method of providing nutrition for an activity, the method including:
consuming blood sugar stabilizing nutrition of a GI of between about 30 and 40 GI for a period of time prior to an activity;
consuming an energy supplement of between about 40 and 50 GI for a period of time prior to an activity;
consuming an energy supplement of between about 50 and 60 GI for a period of time closer to or directly before the activity; and
consuming an energy supplement of between about 60 and 70 GI for an initial period of time during the activity.

Consuming an energy supplement of between about 60 and 70 GI for an initial period of time during the activity may include consuming an energy supplement of between about 60 and 70 GI for an initial period of time of no longer than 90 to 120 minutes during the activity.

The method may further include consuming an energy supplement of between about 70 and 80 GI for a period of time after the initial period of time during the activity.

The method may further include consuming a nano protein supplement during the activity. The supplement may be in the form of a bar or a liquid concentrate. Consuming a nano protein supplement during the activity, may include consuming a nano protein of a hydrolised protein of about 50% to 100%; preferably about 60% to 100%.

Consuming a nano protein supplement during the activity may include consuming a nano protein supplement of relatively low, or zero, GI.

Consuming a nano protein supplement during the activity may include consuming a nano protein supplement of greater than 70% protein content.

Consuming a nano protein supplement during the activity may include consuming a nano protein supplement of from 100 to 4000 Dalton Atomic Weight, preferably 1000 to 3000 Dalton Atomic Weight.

The method may further include consuming a nano protein and carbohydrate supplement after the activity to enhance bodily recovery.

Consuming a nano protein and carbohydrate supplement after the activity to enhance bodily recovery, may include consuming a nano protein and carbohydrate supplement of about 100 GI or more.

Consuming blood sugar stabilizing nutrition of a GI of between about 30 and 40 GI for a period of time prior to an activity, may include consuming blood sugar stabilizing nutrition of a GI of about 35 GI.

Consuming blood sugar stabilizing nutrition of a GI of between about 30 and 40 GI for a period of time prior to an activity, may include consuming blood sugar stabilizing nutrition of a GI of between about 30 and 40 GI for between 48 and 72 hours prior to the activity.

Consuming an energy supplement of between about 40 and 50 GI for a period of time prior to an activity, may include consuming an energy supplement of about 45 GI for a period of time prior to the activity.

Consuming an energy supplement of between about 40 and 50 GI for a period of time prior to an activity, may include consuming an energy supplement of between about 40 and 50 GI for about 48 to 72 hours prior to the activity.

Consuming an energy supplement of between about 50 and 60 GI for a period of time closer to the activity, may include consuming an energy supplement of about 55 GI for a period of time closer to the activity.

Consuming an energy supplement of between about 50 and 60 GI for a period of time closer to the activity, may include consuming an energy supplement of between about 50 and 60 GI for about 2 to 4 hours prior to the activity.

Consuming an energy supplement of between about 60 and 70 GI for an initial period of time during the activity, may include consuming an energy supplement of about 65 GI for an initial period of time during the activity.

Consuming an energy supplement of between about 60 and 70 GI for an initial period of time during the activity, may include consuming an energy supplement of between about 60 and 70 GI for an initial period of not more than 90 to 120 minutes during the activity.

Consuming an energy supplement of between about 70 and 80 GI for a period of time after the initial period of time during the activity, may include consuming an energy supplement of about 75 GI for a period of time after the initial period of time during the activity.

Consuming an energy supplement of between about 70 and 80 GI for a period of time after the initial period of time during the activity, may include consuming an energy supplement of between about 70 and 80 GI after about 90 to 120 minutes of commencement of the activity.

An embodiment of the invention will now be described below.

A nutritional range in accordance with the invention, includes a nutritional range for consumption prior to and during an activity. The nutritional range includes the following phases.

Phase O: This is a meal replacement product which can be used on a daily basis prior to entering phase 1 (as described below) or on a daily basis even though there is no intention to enter phase 1.

The product can be a bar or a ready to drink liquid concentrate. It is used to promote blood sugar stability and is in the form of a single daily serving of less than 110 calories. It is used when the event, for which phase 1 below prepares the user, is still more than 72 hours in the future.

The product comprises complex proteins, hydrolised proteins or a mixture of both and can be plant or animal based.

The product is typically very low in fat or fat free and devoid of any sugar, starches or glycemic carbohydrates. It can also contain erythritol and stevia glycoside. The natural sweetener stevia glycoside can be replaced by an artificial sweetener. Erythritol can be replaced by any sugar substitute which is not a carbohydrate.

It contains nutritional or dietary fibre.

Phase 1: Provides for blood sugar stability. This is achieved by a relatively low GI meal or supplement of about 35 GI. The meal or supplement can be in the form of a bar or a [goo] or can be in a ready to drink format. By providing such a relatively low GI meal or supplement, glycogen conversion is enhanced so as to enhance muscle energy. Blood sugar spikes or dips within 48 hours of an activity typically compromises glycogen conversion and muscle energy levels thereby reducing performance levels during the activity.

By using a 35 GI meal replacement, blood sugar levels are stabilized so as to provide enhanced glycogen conversion. It has been found that the human body typically burns fat for energy when blood sugar levels are stable. Accordingly, a 35 GI nutritional regime enhances weight loss for dieters.

Phase 1 is typically used for preparation for any approaching activity as a MRP (meal replacement product) or as a 48 hour pre activity MRP to enhance glycogen conversion.

Phase 2 provides for an energy supplement, such as an energy drink, carbohydrate loader, powder supplement, or the like, having 45 GI. Typically, this is a carbohydrate supplement for consumption during a 48 hour period prior to an activity. It can, however, contain protein and fat and may be provided in bar or ready to drink liquid concentrate format. This supplement is typically used as a preparation for any activity. Typically, this supplement is ideal as a preparation for a relatively low intensity activity, such as golf, cricket, and the like, for example.

Phase 3 provides for an energy supplement, such as an energy drink, carbohydrate loader, powder supplement, or the like, having 55 GI. It can, however, contain protein and fat and may be provided in bar or ready to drink liquid concentrate format. Typically, this is a carbohydrate supplement for consumption during a 2 hour period prior to a relatively intense or extremely intense, activity. As a person starts to prepare for such an activity, a person begins to be more active and a person's heart rate starts to increase. The 55 GI supplement compensates for this change in nutritional requirement. This supplement can be used advantageously once the activity has started and during medium intensity activities. Such activities include rugby, gym, cricket bowlers, and the like, for example.

Phase 4 provides for an energy supplement, such as an energy drink, carbohydrate loader, powder supplement, or the like, having 65 GI. It can, however, contain protein and fat and may be provided in bar or ready to drink liquid concentrate format. This supplement is used in a case where the activity is of a relatively high intensity having a relatively short duration of about 120 minutes, or the like, for example. This supplement can typically be used for activities such as tennis, the second half of a rugby match, and the like, for example. For activities of a longer duration, such as cycling, or the like, for example, this supplement is used for about the first 120 minutes of the activity.

Phase 5 provides for an energy supplement, such as an energy drink, carbohydrate loader, powder supplement, or the like, having 75 GI. It can, however, contain protein and fat and may be provided in bar or ready to drink liquid concentrate format. This supplement is used in a case where the activity is of a relatively high intensity having a relatively long duration, such as cycling, or the like, for example. This supplement is used after phase 4 after about 120 minutes of the activity. The phase 4 supplement is to be used during the first 120 minutes of the activity.

Phase 6 provides for a nano protein and carbohydrate supplement, such as, a nano protein gel, or the like, for example, having about IOOGI. It can, however, contain protein and fat and may be provided in bar or ready to drink liquid concentrate format. This supplement is consumed after the activity to enhance bodily recovery after the activity. The nano aspect of the supplement enhances rapid absorption of protein and carbohydrate thereby to enhance recovery.

Supplements include proteins, fats, vitamins and minerals. Nano proteins include dairy protein, plant protein, hydrolyzed and L-form amino acids.

1. A nutrition kit including:
a blood sugar stabilizing nutrition of a GI of between 30 and 40 GI to be consumed for a period of time prior to an activity;
an energy supplement of between about 40 and 50 GI to be consumed for a period of time prior to an activity;
an energy supplement of between 50 and 60 GI to be consumed for a period of time closer to the activity;
an energy supplement of between 60 and 70 GI to be consumed for an initial period of time during the activity;
an energy supplement of between 70 an 80 GI to be consumed during the activity for a period of time after said initial period of time during the activity.

2. The kit according to claim 1, wherein the initial period is no longer than 120 minutes.

3-14. (canceled)

15. The kit according to claim 1, wherein the energy supplement of between 60 and 70 GI has a GI of about 65.

16. The kit according to claim 1, and including instructions instructing a consumer to consume the energy supplement of between 60 and 70 GI for a period of time less than about 120 minutes after commencement of the activity.

17. The kit according to claim 1, wherein the energy supplement of between 70 and 80 GI has a GI of about 75.

18. The kit according to claim 1, including instructions instructing a consumer to consume the energy supplement of between 70 and 80 GI after about 120 minutes after commencement of the activity.

19. A nutritional range including:
a container containing a blood sugar stabilizing nutrition of a GI of between 30 and 40 GI to be consumed for a period of time prior to an activity;
a container containing an energy supplement of between 40 and 50 GI to be consumed for a period of time prior to an activity;
a container containing an energy supplement of between 50 and 60 GI to be consumed for a period of time closer to the activity;
a container containing an energy supplement of between 60 and 70 GI to be consumed for an initial period of time during the activity; and
a container containing an energy supplement of between 70 and 80 GI to be consumed during the activity for a period of time after the initial period.

20. The range according to claim 19, wherein the container containing the energy supplement of between 60 and 70 GI to be consumed for an the initial period of time during the activity is for an initial period of no more than 120 minutes.

21-33. (canceled)

34. The range according to claim 19, wherein the energy supplement of between 60 and 70 GI has a GI of about 65.

35. The range according to claim 19, and including instructions instructing a consumer to consume the energy supplement of between 60 and 70 GI for a period of less than 120 minutes during the activity.

36. The range according to claim 19, wherein the energy supplement of between 70 and 80 GI has a GI of about 75.

37. The range according to claim 19 including instructions instructing a consumer to consume the energy supplement of between 70 and 80 GI after about 120 minutes after commencement of the activity.

38. A method of providing nutrition for an activity, the method including:
consuming blood sugar stabilizing nutrition of a GI of between 30 and 40 GI for a period of time prior to an activity;
consuming an energy supplement of between 40 and 50 GI for a period of time prior to an activity;
consuming an energy supplement of between 50 and 60 GI for a period of time closer to or directly before the activity;
consuming an energy supplement of between 60 and 70 GI for an initial period of time during the activity; and
consuming an energy supplement of between 70 and 80 GI for a period of time during the activity, after the initial period of time.

39. The method according to claim 38; wherein the initial period of time during the activity is no longer than 90 to 120 minutes.

40-54. (canceled)

55. The method according to claim 38, wherein consuming an energy supplement of between 60 and 70 GI for an initial period of time during the activity comprises the step of consuming an energy supplement of about 65 GI for an initial period of time during the activity.

56. The method according to claim 38, wherein consuming an energy supplement of between 60 and 70 GI for an initial period of time during the activity comprises the step of consuming an energy supplement of between 60 and 70 GI for an initial period of not more than 90 to 120 minutes during the activity.

57. The method according to claim 38, wherein consuming an energy supplement of between 70 and 80 GI for a period of time after the initial period of time during the activity comprises the step of consuming an energy supplement of about 75 GI for a period of time after the initial period of time during the activity.

58. The method according to claim 38, wherein consuming an energy supplement of between 70 and 80 GI for a period of time after the initial period of time during the activity comprises the step of consuming an energy supplement of between 70 and 80 GI after about 90 to 120 minutes of commencement of the activity.
